(19) United States
(12) Patent Application Publication
(10) Pub. No.: US 2015/0188802 A1
(43) Pub. Date: Jul. 2, 2015

(54) SYSTEM FOR SUPPORTING MULTI-TENANT BASED ON PRIVATE IP ADDRESS IN VIRTUAL PRIVATE CLOUD NETWORKS AND OPERATING METHOD THEREOF

(71) Applicant: ELECTRONICS AND TELECOMMUNICATIONS RESEARCH INSTITUTE, Daejeon (KR)

(72) Inventors: Hyeon-Sik YOON, Daejeon (KR); Hea-Sook PARK, Daejeon (KR); Boo-Geum JUNG, Daejeon (KR)

(21) Appl. No.: 14/551,400

(22) Filed: Nov. 24, 2014

(30) Foreign Application Priority Data
Dec. 26, 2013 (KR) 10-2013-0164653

(51) Int. Cl. H04L 12/721

(52) U.S. Cl. CPC H04L 45/14

(57) ABSTRACT

A system includes: a map-server storing EID-RLOC mapping information; an ITR receiving RLOC information on a corresponding EID from an ETR designated by the map-server based on a destination EID and a tenant identifier of a corresponding enterprise network when receiving packets for requesting allocation of computing resources from a terminal within the enterprise networks, generating an LISP data packet based on the received RLOC information and the RLOC information of the corresponding enterprise network, and transmitting the generated LISP data packet to a backbone network; and an ETR requesting the computing resources to a corresponding server within a cloud center based on the received LISP data packet to receive information on the computing resources from the server as an answer to the request when receiving the LISP data packet through the backbone network and providing the received information on the computing resources to the ITR

### CROSS REFERENCE TO RELATED APPLICATION

This application claims the benefit of Korean Patent Application No. 10-2013-0164653, filed on Dec. 26, 2013, entitled “System For Supporting Multi-Tenant Based On Private IP Address In Virtual Private Cloud Networks And Operating Method Thereof”, which is hereby incorporated by reference in its entirety into this application.

### BACKGROUND

1. Technical Field

The present invention relates to a technology for supporting multi-tenant based on a private IP address, and more particularly, to a system for supporting multi-tenant based on a private IP address in virtual private cloud networks capable of identifying each tenant in the entire network by adding identifiers for identifying each tenant to EID-RLOC mapping information which is configured of EID for identifying individual terminals and RLOC for identifying positions of networks to which the corresponding terminals belong, and an operating method thereof.

2. Description of the Related Art

At present, as a cloud computing based smart work technology evolves, a virtual private cloud technology to safely secure private cloud services via the Internet has received a lot of attention. Herein, the virtual private cloud technology is a technology to store user services or applications in a common server, not in a user desktop and use the user services or applications whenever the user services or applications are needed and means services for a user to receive the same operating environment as environment in which enterprises offer services even though enterprises or individual clouds are present in a common or public cloud.

To provide the virtual private cloud services, a service provider needs to support multi-tenants and the multi-tenants which are logically separated from each other need to share network resources and computing resources for virtual private cloud services. Herein, the tenant is a term representing a group of users belong to one organization such as company, institution, and etc.

To provide the virtual private cloud services for the multi-tenants, the service provider needs to provide cloud services based on private IP addresses used in each enterprise network, guarantee security between the respective tenants, and assure extensibility for supporting the multi-tenants sharing the network and computing resources.

Further, in case of using the private IP address, each tenant may use the same private IP addresses, which does not cause any problem in each enterprise network but may cause any problem in a cloud center due to the duplication of the same private IP addresses. Therefore, a need exists for a method for supporting multi-tenants using the same private IP address in the virtual private cloud networks.

### SUMMARY

The present invention has been made in an effort to provide a system for supporting multi-tenant based on a private IP address in virtual private cloud networks capable of identifying each tenant in the entire network by adding identifiers for identifying each tenant to EID-RLOC mapping information which is configured of EID for identifying individual terminals and RLOC for identifying positions of networks to which the corresponding terminals belong, and an operating method thereof.

However, objects of the present invention are not limited to the above-mentioned matters and other objects can be clearly understood to those skilled in the art from the following descriptions.

According to an exemplary embodiment of the present invention, there is provided a system for supporting multi-tenant based on a private IP address, including: a map-server configured to store endpoint identifier-routing locator (EID-RLOC) mapping information; an ingress tunnel router (ITR) configured to receive RLOC information on a corresponding EID from an ETR designated by the map-server based on a destination EID and a tenant identifier of a corresponding enterprise network when receiving packets for requesting allocation of computing resources from terminals within the enterprise networks, generate an LISP data packet based on the received RLOC information and the RLOC information of the corresponding enterprise network, and transmit the generated LISP data packet to a backbone network; and an egress tunnel router (ETR) configured to request the computing resources to a corresponding server within a cloud center based on the received LISP data packet to receive information on the computing resources from the server as an answer to the request when receiving the LISP data packet through the backbone network, and provide the received information on the computing resources to the ITR.

The ITR may construct an IP header including the RLOC information on the destination EID received from the ETR designated by the map-server which is set as a destination IP address and the RLOC information of the corresponding enterprise network which is set as a source IP address and encapsulate the packet with the constructed IP header to generate the LISP data packet.

The ITR may drop the packet received from the terminal or process the packet according to a previously configured policy when the ITR does not receive the RLOC information on the destination EID.

When recognizing the EID of the server within the cloud center requesting a connection setting, the ETR may generate an LISP control message including the recognized EID of the server and the RLOC of the cloud center and transmit the generated LISP control message to the map-server to register the EID-RLOC mapping information on the server.

The ETR may decapsulate the IP header in the received LISP data packet and add a VLAN ID previously allocated to the corresponding tenant to the packet for requesting the allocation of the computing resources when the ETR receives the LISP data packet through the backbone network and then transmit the packet to the destination EID.

The ETR may receive the packet including the information on the computing resources from the server, construct an IP header including the RLOC information on the enterprise network which is set as a destination IP address and the RLOC information on an EID of the server which is set as a source IP address, encapsulate the packet with the constructed IP header to generate the LISP data packet, and provide the generated LISP data packet to the ITR.

The EID-RLOC mapping information may include an EID for identifying an individual terminal, a RLOC for identifying a position of a network to which the corresponding terminal belongs, and an identifier for identifying each tenant in the entire network.

According to another exemplary embodiment of the present invention, there is provided an operating method for supporting multi-tenant based on a private IP address, including: constructing, by a map-server, endpoint identifier-routing locator (EID-RLOC) mapping information; receiving, by an ingress tunnel router (ITR), RLOC information, on a corresponding EID from an ETR designated by the map-server based on a destination EID and a tenant identifier of a corresponding enterprise network when the ITR receives packets for requesting allocation of computing resources from terminals within the enterprise networks, generating an LISP data packet based on the received RLOC information and the RLOC information of the corresponding enterprise network, and transmitting the generated LISP data packet to a backbone network; and requesting, by an egress tunnel router (ETR), the computing resources to the corresponding server within a cloud center based on the received LISP data packet to receive information on the computing resources from the server as an answer to the request when the ETR receives the LISP data packet through the backbone network and providing the received information on the computing resources to the ITR.

In the constructing, when an EID of the terminal within the enterprise network requesting a connection setting is recognized, an LISP control message including the recognized EID of the terminal and the RLOC of the enterprise network to which the terminal belongs may be generated and the generated LISP control message may be transmitted to the map-server to register the EID-RLOC mapping information on the terminal.

In the transmitting, an IP header may include the RLOC information on the destination EID received from the ETR designated by the map-server which is set as a destination IP address and the RLOC information of the corresponding enterprise network which is set as a source IP address and the packet may be encapsulated with the IP header to generate the LISP data packet.

In the transmitting, when the RLOC information on the destination EID is not received, the packet received from the terminal may be dropped or the packet may be processed according to a previously configured policy.

In the constructing, when an EID of the server within the cloud center requesting a connection setting is recognized, an LISP control message including the recognized EID of the server and the RLOC of the cloud center may be generated and the generated LISP control message may be transmitted to the map-server to register the EID-RLOC mapping information on the server.

In the providing, when the LISP data packet is received through the backbone network, the IP header in the received LISP data packet may be decapsulated and a VLAN ID previously allocated to the corresponding tenant may be added to the packet for requesting the allocation of the computing resources and then the packet is transmitted to the destination EID.

In the providing, the packet including the information on the computing resources may be received from the server, an IP header may include the RLOC information on the enterprise network which is set as a destination IP address and the RLOC information on an EID of the server which is set as a source IP address, the packet may be encapsulated with the constructed IP header to generate the LISP data packet, and the generated LISP data packet may be provided to the ITR.

The EID-RLOC mapping information may include an EID for identifying an individual terminal, a RLOC for identifying a position of a network to which the corresponding terminal belongs, and an identifier for identifying each tenant in the entire network.

### BRIEF DESCRIPTION OF THE DRAWINGS

FIG. 1 is a diagram representing a system for supporting multi-tenant in a virtual private cloud network based on an LISP according to an exemplary embodiment of the present invention.

FIG. 2 is a diagram illustrating a process of registering EID-RLOC mapping information according to an exemplary embodiment of the present invention.

FIG. 3 is a diagram illustrating an operating method for supporting multi-tenant according to an exemplary embodiment of the present invention.

FIG. 4 is a diagram illustrating an IP header format of an LISP data packet according to an exemplary embodiment of the present invention.

FIG. 5 is a diagram for describing an operating method of ITR according to an exemplary embodiment of the present disclosure.

FIG. 6 is a diagram for describing an operating method of ETR according to an exemplary embodiment of the present disclosure.

### DESCRIPTION OF EXEMPLARY EMBODIMENTS

Hereinafter, a system for supporting multi-tenant based on a private IP address in virtual private cloud networks according to an exemplary embodiment of the present invention and an operating method thereof will be described with reference to the accompanying drawings. Components required to understand an operation and an action according to the exemplary embodiment of the present invention will be mainly described in detail.

In addition, in describing components of the present invention, like components may be denoted by different reference numerals throughout the drawings and may also be denoted by like reference numerals despite different drawings. However, even in the above-mentioned case, the corresponding components mean having different functions according to exemplary embodiments or do not mean having the same function in different exemplary embodiments and functions of each component are to be understood based on the description of each component in the corresponding exemplary embodiment.

In particular, according to the exemplary embodiment of the present invention, a new operating method for identifying each tenant in the entire network by adding identifiers, that is, tenant identifiers for identifying each tenant to EID-RLOC mapping information which is configured of EID for identifying individual terminals and RLOC for identifying positions of networks to which the corresponding terminals belong in virtual private cloud networks based on locator/ID separation protocol (LISP) is proposed.

In this case, the LISP divides an address system into the EID for identifying individual terminals and the RLOC for identifying positions of networks to which the corresponding terminals belong, defines a set of information which is exchanged by routers for mapping of the EID and the RLOC, and defines a mechanism of a router to route and forward packets transmitted from the terminals to other terminals through a backbone network.

The LISP standard is defined in the Internet Engineering Task Force (IETF), and as the LISP standard, there are RFC6830, RFC6831, RFC6832, RFC6833, RFC6834, RFC6835, RFC6836, RFC6837, and the like.

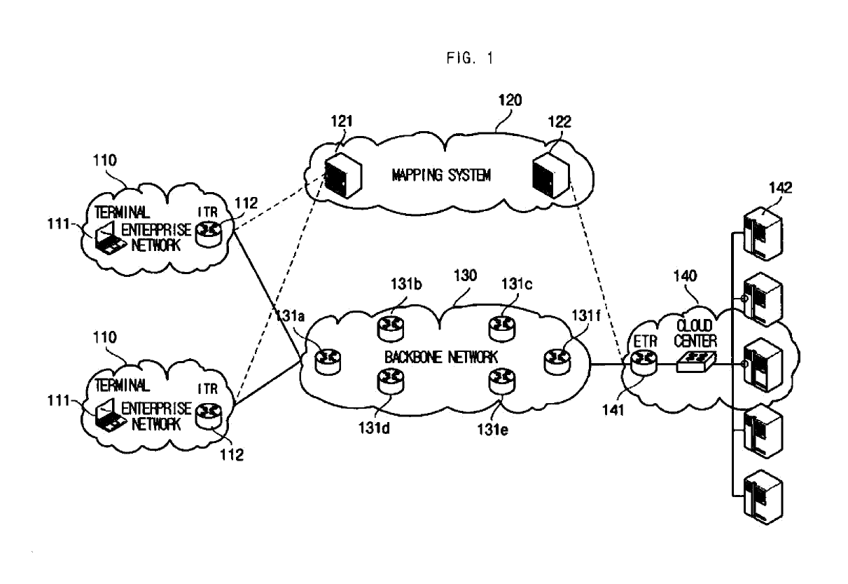

FIG. 1 is a diagram representing a system for supporting multi-tenant in a virtual private cloud network based on an LISP according to an exemplary embodiment of the present invention.

As illustrated in FIG. 1, a system for supporting multi-tenant according to an exemplary embodiment of the present invention may be configured to include a subscriber terminal or a terminal 111, an ingress tunnel router (ITR) 112, a map-resolver 121, a map-server 122, a backbone router 131, an egress tunnel router (ETR) 141, a server 142, and the like.

At least one terminal 111 and one ITR 112 are on an enterprise network 110 and may form one tenant. The enterprise network or the tenant is connected to a cloud center 140 through a backbone network 130 and receives computing resources from the connected cloud center 140.

In this case, the computing resources may include applications, CPU processing capacity, storage capacity, and the like.

The ITR 112 is located at a boundary at which the enterprise network is connected to the backbone network to perform functions related to the LISP. That is when receiving packets for utilizing the computing resources from the terminal, the ITR 112 requests RLOC information on the corresponding EID to the map-resolver based on a destination EID and a tenant identifier of the corresponding enterprise network and receives the RLOC information as an answer to the request to generate LISP data packet using the received RLOC information as a destination IP address and the RLOC information of the corresponding enterprise network as a source IP address and transmit the generated LISP data packet to the backbone network.

The map-resolver 121 and the map-server 122 may form a mapping system. That is, when receiving a request for the RLOC information from the ITR, the map-resolver 121 serves to transmit the corresponding request to the map-server 122, and the map-server 122 serves to transmit the request to the ETR 141 which manages the corresponding EID based on a search of the EID-RLOC mapping information.

The map-resolver 121 and the map-server 122 may be implemented on one system but are not necessarily limited thereto, and therefore may be implemented on a separate system as needed.

The plurality of backbone routers 131 may form the backbone network to perform a routing function. The backbone router 131 may perform the same functions as the routers generally used and perform routing based on the IP address used as the RLOC information. That is, the backbone router 131 may receive the LISP data packet from the ITR 112 within the enterprise network 110 and route the received LISP data packet to the ETR 141 within the cloud center 140.

The ETR 141 and at least one server 142 may form the cloud center 140. The ETR 141 may receive the LISP data packet through the backbone router 131 within the backbone network 130 and transmit the received LISP data packet to the server 142 within the cloud center 140.

The server 142 may receive the LISP data packet from the ETR 141 and transmit the information requested by the terminal 111 within the enterprise network 110 based on the received LISP data packet.

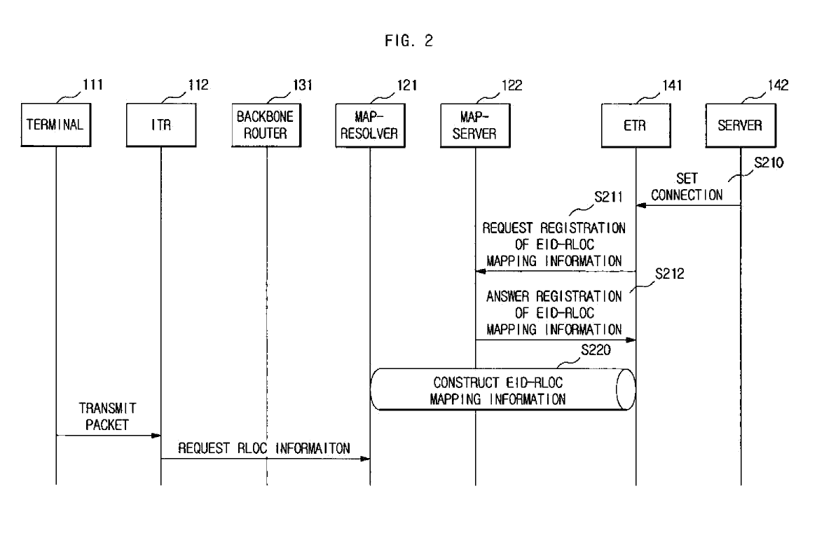

FIG. 2 is a diagram illustrating a process of registering EID-RLOC mapping information according to an exemplary embodiment of the present invention.

As illustrated in FIG. 2, first, when the server 142 within the cloud center requests the connection setting to the ETR 141 (S210), the ETR 141 may recognize the EID of the server 142 which requests the connection setting.

Next, when recognizing the EID of the server 142 which requests the connection setting, the ETR 141 may generate the LISP control message including the recognized EID of the server and the RLOC of the cloud center to which the server belongs and transmit the generated LISP control message to the map-server to request the registration of the EID-RLOC mapping information (S211).

Next, the map-server 122 may generate the EID-RLOC mapping information on the corresponding server based on the transmitted LISP control message and store and register the generated EID-RLOC mapping information.

Next, the map-server 122 may inform the ETR that the EID-RLOC mapping information is registered (S212).

Further, the terminal 111 may register the EID-RLOC mapping information in the map-server 122 through the ETR within the enterprise network to which the terminal 111 belongs. Meanwhile, this registration process is the same as the registration process of the server 142 and therefore the detailed description thereof will be omitted.

By this process, the map-server 122 may construct the EID-RLOC mapping information on the entire network (S220). Herein, the EID-RLOC mapping information is implemented as {EID, RLOC, tenant identifier}.

Further, the present invention describes, by way of example, the case in which the map-server manages the EID-RLOC mapping information on the entire network but is not necessarily limited thereto and therefore the ITR and the ETR may also partially manage the EID-RLOC mapping information and may be operated based thereon.

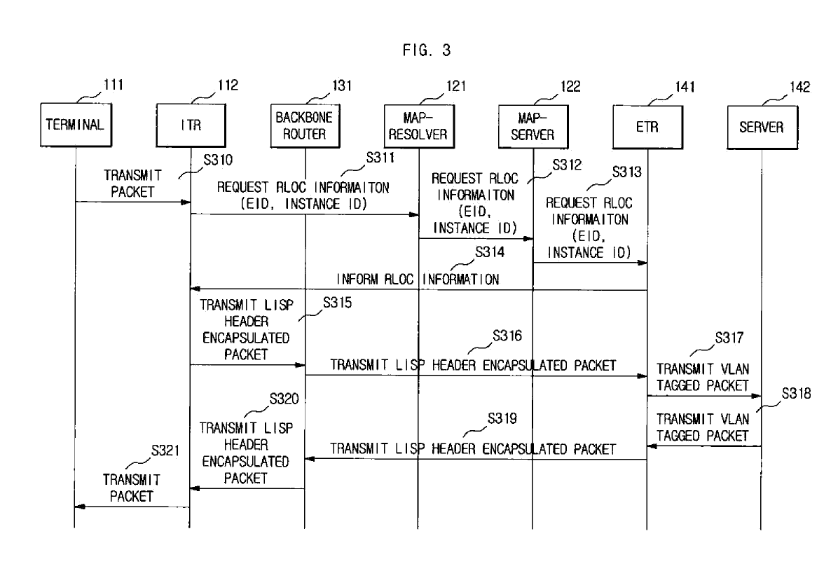

FIG. 3 is a diagram illustrating an operating method for supporting multi-tenant according to an exemplary embodiment of the present invention.

As illustrated in FIG. 3, first, the terminal 111 within the enterprise network may generate packets for utilizing computing resources of the cloud center and transmit the generated packets to the ITR 112 (S310). Here, the packet may include the destination EID and the tenant identifier of the corresponding enterprise network.

In this case, the tenant identifier needs to be previously set by an operator so as to be uniquely identified in the entire network and as the tenant identifier, for example, an MPLS label, a VLAN ID, and the like may be used.

Next, the ITR 112 may request the RLOC information on the corresponding EID to the map-resolver based on the destination ED and the tenant identifier of the corresponding enterprise network which are included in the transmitted packet. The reason is that the ITR 112 does not initially have the RLOC information of the cloud center to which the corresponding server belongs.

Next, the map-resolver 121 may request the RLOC information on the corresponding EID to the map-server 122 based on the received destination EID and tenant identifier of the corresponding enterprise network (S312) and the map-server 122 may request the RLOC information on the corresponding EID to the ETR 141 (S313).

Next, the ETR 141 may provide the RLOC information on the EID to the ITR 112 (S314).

Next, the ITR 112 may construct the IP header including the received RLOC information on the destination EID which is set as a destination IP address and the RLOC information of the corresponding enterprise network which is set as a source IP address, encapsulate the packet with the constructed IP header to generate the LISP data packet, and transmit the generated LISP data packet to the backbone router within the backbone network (S315).

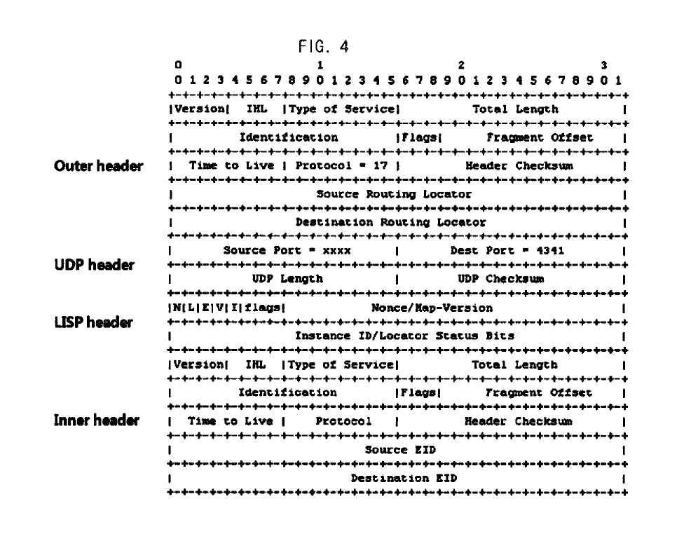

FIG. 4 is a diagram illustrating an IP header format of an LISP data packet according to an exemplary embodiment of the present invention.

As illustrated in FIG. 4, the IP header of the LISP data packet according to the exemplary embodiment of the present invention may include an external header, a UDP header, an LISP header, an internal header, and the like. In particular, according to the exemplary embodiment of the present invention, the tenant identifier may be inserted into an instance ID field within the LISP header and transmitted.

Next, the backbone router 131 may receive the LISP data packet from the ITR 112 and transmit the received LISP data packet to the ETR 141 within the cloud center 140 based on the RLOC information of the IP header within the received LISP data packet (S316).

Next, the ETR 141 may receive the LISP data packet and decapsulate the IP header in the received LISP data packet to transmit the corresponding packet to the destination EID (S317). In particular, the ETR 141 adds the VLAN ID allocated to the corresponding tenant to the packet and then transmits the packet to the destination EID. The reason is that when the VLAN IDs are different in the case which the packets are transmitted by switches within the cloud center, a separation between other tenants is guaranteed.

Next, the server 142 may generate the packet including the information on the computing resource according to the request of the terminal 111 and transmit the generated packet to the ETR 141 (S318).

Next, the ETR 141 may receive the packet from the server, construct the IP header including the RLOC information of the enterprise network which is set as the destination IP address and the RLOC information on an EID of the server which is set as the source IP address, encapsulate the packet with the constricted IP header to generate the LISP data packet, and transmit the generated LISP data packet to the backbone router within the backbone network (S319).

Next, the backbone router 131 may receive the LISP data packet from the ETR 141 and transmit the received LISP data packet to the ITR within the enterprise network based on the RLOC information of the IP header within the received LISP data packet (S320).

Next, the ITR 112 may receive the LISP data packet and decapsulate the IP header in the received LISP data packet to transmit the corresponding packet to the source EID, that is, the terminal (S321).

A cloud provider which provides the virtual private cloud service according to an embodiment of the present invention may provide the cloud service while providing safe security between the tenants to the multi-tenants using the same private IP address.

The ITR of the enterprise network and the ETR of the cloud center which are described in the exemplary embodiment of the present invention are differentiated according to a flow of traffic and one router may substantially serve to simultaneously perform the ITR and the ETR. For example, the ITR of the enterprise network may serve as the ETR or the ETR of the cloud center may serve as the ITR. Further, each of the enterprise networks or the cloud centers may use separate ITR and ETR and may also use a plurality of ITRs and ETRs.

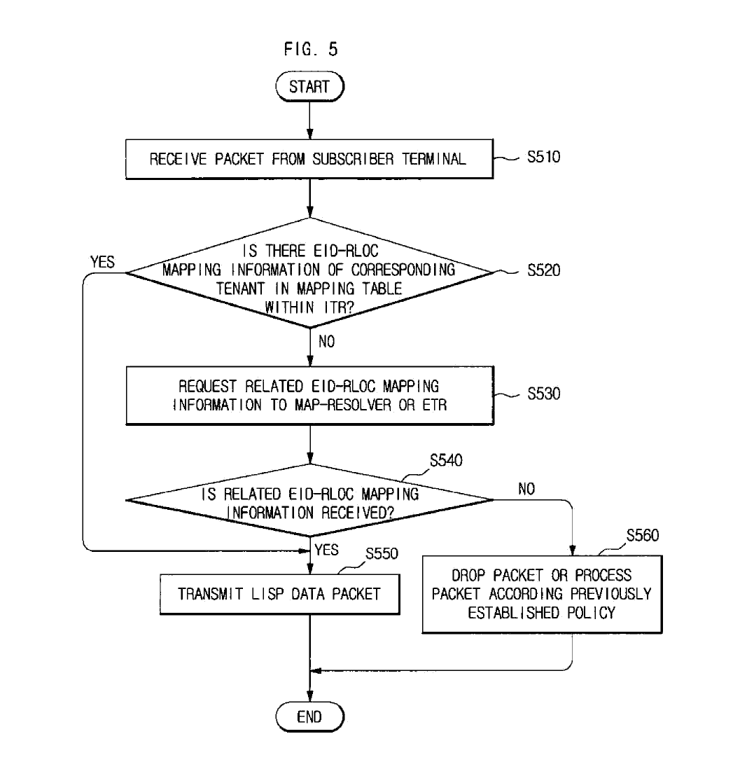

FIG. 5 is a diagram for describing an operating method of ITR according to an exemplary embodiment of the present disclosure.

As illustrated in FIG. 5, when the ITR according to the exemplary embodiment of the present invention receives the packet from the terminal within the enterprise network (S510), it may confirm whether the EID-RLOC mapping information of the corresponding destination is present in an internal mapping table (S520).

Next, as the confirmed result, if it is confirmed that the EID-RLOC mapping information of the corresponding destination is present, the ITR may generate the LISP data packet based on the EID-RLOC mapping information of the corresponding destination and transmit the generated LISP data packet (S550).

On the other hand, as the confirmed result, if it is confirmed that the EID-RLOC mapping information of the corresponding destination is not present, the ITR may request the EID-RLOC mapping information of the corresponding destination to the map-resolver or the ETR (S530).

Next, the ITR may confirm whether the EID-RLOC mapping information of the corresponding destination is received (S540).

Next, if it is confirmed that the EID-RLOC mapping information of the corresponding destination is received, the ITR may generate the LISP data packet based on the EID-BLOC mapping information of the corresponding destination and transmit the generated LISP data packet (S550).

On the other hand, if it is confirmed that the EID-RLOC mapping information of the corresponding destination is not received, the ITR may drop the corresponding packet or process the corresponding packet according to a previously configured policy (S560).

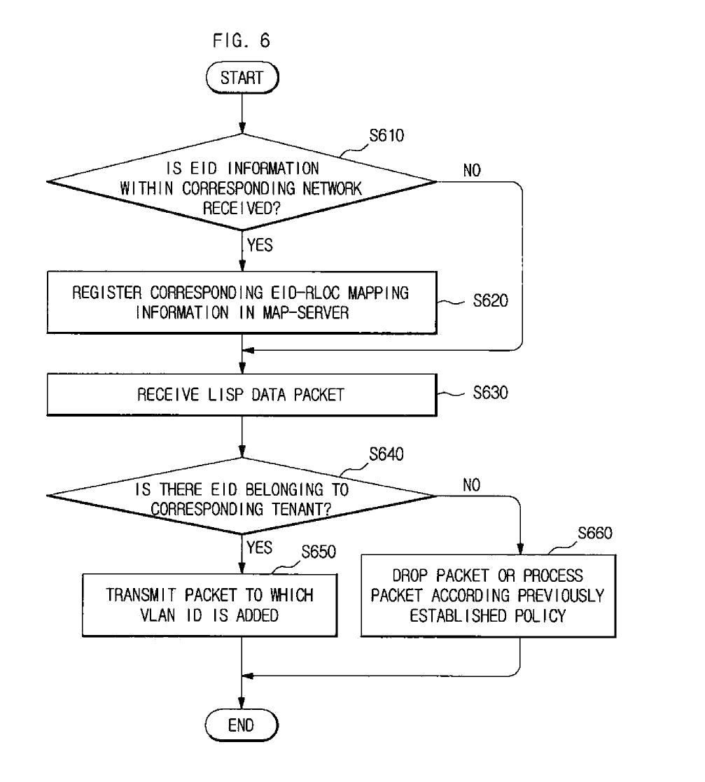

FIG. 6 is a diagram for describing an operating method of ETR according to an exemplary embodiment of the present disclosure.

As illustrated in FIG. 6, the ETR according to the exemplary embodiment of the present invention confirms whether the EID information within the corresponding network is received (S610) and if it is confirmed that the EID information is received, the ETR may register the corresponding EID-RLOC mapping information in the map-server (S620).

Next, when the ETR receives the LISP data packet from the backbone router within the backbone network (S630), it may confirm whether the EID belonging to the corresponding tenant or server is present (S640).

Next, if it is confirmed that the EID belonging to the corresponding tenant is present, the ETR may decapsulate the IP header within the received LISP data packet and add the VLAN ID allocated to the corresponding tenant to the decapsulated corresponding packet and then transmit the packet to the destination EID (S650).

On the other hand, if it is confirmed that the EID belonging to the corresponding tenant or server is not present, the ETR may drop the corresponding packet or process the corresponding packet according to a previously configured policy (S660).

Meanwhile, the embodiment of the present invention describes that all the components configuring the present invention as described above are coupled in one or are operated, being coupled with each other, but is not necessarily limited thereto. That is, all the components may be operated, being optionally coupled with each other within the scope of the present invention. Further, all the components may be each implemented in one independent hardware, but a part or all of each component may be selectively combined to be implemented as a computer program having a program module performing some functions or all the functions combined in one or a plurality of hardwares. Further, the computer program is stored in computer readable media, such as a USB memory, a CD disk, a flash memory, and the like, to be read and executed by a computer, thereby implementing the exemplary embodiment of the present invention. An example of the storage media of the computer program may include a magnetic recording medium, an optical recording medium, a carrier wave medium, and the like.

As set forth above, according to the exemplary embodiments of the present invention, the identifiers for identifying each tenant may be added to the EID-RLOC mapping information which is configured of the EID for identifying the individual terminals and the RLOC for identifying the position of the network to which the corresponding terminal belongs to identify each tenant in the entire network, such that the existing enterprise network users may safely use the cloud services without translating the used private IP addresses.

Further, according to the exemplary embodiments of the present invention, the existing enterprise network users may safely use the cloud services without translating the used private IP addresses to improve the convenience and guarantee the security, thereby contributing to the activation of the virtual private cloud services.

A person with ordinary skilled in the art to which the present invention pertains may variously change and modify the foregoing exemplary embodiments without departing from the scope of the present invention. Accordingly, the embodiments disclosed in the present invention and the accompanying drawings are used not to limit but to describe the spirit of the present invention. The scope of the present invention is not limited only to the embodiments and the accompanying drawings. The protection scope of the present invention must be analyzed by the appended claims and it should be analyzed that all spirits within a scope equivalent thereto are included in the appended claims of the present invention.

What is claimed is:

1. A system for supporting multi-tenant based on a private IP address, comprising:
a map-server configured to store endpoint identifier-routing locator (EID-RLOC) mapping information;
an ingress tunnel router (ITR) configured to receive RLOC information on a corresponding EID from an ETR designated by the map-server based on a destination EID and a tenant identifier of a corresponding enterprise network when receiving packets for requesting allocation of computing resources from a terminal within the enterprise networks, generate an LISP data packet based on the received RLOC information and the RLOC information of the corresponding enterprise network, and transmit the generated LISP data packet to a backbone network; and
an egress tunnel router (ETR) configured to request the computing resources to a corresponding server within a cloud center based on the received LISP data packet to receive information on the computing resources from the server as an answer to the request when receiving the LISP data packet through the backbone network, and provide the received information on the computing resources to the ITR.

2. The system of claim 1, wherein the ITR constructs an IP header including the RLOC information on the destination EID received from the ETR designated by the map-server which is set as a destination IP address and the RLOC information of the corresponding enterprise network which is set as a source IP address and encapsulates the packet with the constructed IP header to generate the LISP data packet.

3. The system of claim 2, wherein the ITR drops the packet received from the terminal or processes the packet according to a previously configured policy when the ITR does not receive the RLOC information on the destination EID.

4. The system of claim 1, wherein when recognizing an HD of the server within the cloud center requesting a connection setting, the ETR generates an LISP control message including the recognized EID of the server and the RLOC of the cloud center and transmits the generated LISP control message to the map-server to register the EID-RLOC mapping information on the server.

5. The system of claim 1, wherein when receiving the LISP data packet through the backbone network, the ETR decapsulates the IP header in the received LISP data packet and adds a VLAN ID previously allocated to the corresponding tenant to the packet for requesting the allocation of the computing resources and then transmits the packet to the destination EID.

6. The system of claim 1, wherein the ETR receives the packet including the information on the computing resources from the server, constructs an IP header including the RLOC information on the enterprise network which is set as a destination IP address and the RLOC information on an EID of the server which is set as a source IP address, encapsulates the packet with the constructed IP header to generate the LISP data packet, and provides the generated LISP data packet to the ITR.

7. The system of claim 1, wherein the EID-RLOC mapping information includes an EID for identifying an individual terminal, a RLOC for identifying a position of a network to which the corresponding terminal belongs, and an identifier for identifying each tenant in the entire network.

8. An operating method for supporting multi-tenant based on a private IP address, comprising:
constructing, by a map-server, endpoint identifier-routing locator (EID-RLOC) mapping information;
receiving, by an ingress tunnel router (ITR), RLOC information on a corresponding EID from an ETR designated by the map-server based on a destination EID and a tenant identifier of a corresponding enterprise network when the ITR receives packets for requesting allocation of computing resources from terminals within the enterprise networks, generating an LISP data packet based on the received RLOC information and the RLOC information of the corresponding enterprise network, and transmitting the generated LISP data packet to a backbone network; and
requesting, by an egress tunnel router (ETR), the computing resources to a corresponding server within a cloud center based on the received LISP data packet to receive information on the computing resources from the server as an answer to the request when the ETR receives the LISP data packet through the backbone network and provide the received information on the computing resources to the ITR.

9. The operating method of claim 8, wherein in the constructing, when an EID of the terminal within the enterprise network requesting a connection setting is recognized, an LISP control message including the recognized EID of the terminal and the RLOC of the enterprise network to which the terminal belongs is generated and the generated LISP control message is transmitted to the map-server to register the EID-RLOC mapping information on the terminal.

10. The operating method of claim 8, wherein in the transmitting, an IP header includes the RLOC information on the destination EID received from the ETR designated by the map-server which is set as a destination IP address and the RLOC information of the corresponding enterprise network which is set as a source IP address and the packet is encapsulated with the IP header to generate the LISP data packet.

11. The operating method of claim 10, wherein in the transmitting, when the RLOC information on the destination EID is not received, the packet received from the terminal is dropped or the packet is processed according to a previously configured policy.

12. The operating method of claim 8, wherein in the constructing, when an EID of the server within the cloud center requesting a connection setting is recognized, an LISP control message including the recognized EID of the server and the RLOC of the cloud center is generated and the generated LISP control message is transmitted to the map-server to register the EID-RLOC mapping information on the server.

13. The operating method of claim 8, wherein in the providing, when the LISP data packet is received through the backbone network, the IP header in the received LISP data packet is decapsulated and a VLAN ED previously allocated to the corresponding tenant is added to the packet for requesting the allocation of the computing resources and then the packet is transmitted to the destination EID.

14. The operating method of claim 8, wherein in the providing, the packet including the information on the computing resources is received from the server, an IP header includes the RLOC information on the enterprise network which is set as a destination IP address and the RLOC information on an EID of the server which is set as a source IP address, the packet is encapsulated with the constructed IP header to generate the LISP data packet, and the generated LISP data packet is provided to the ITR.

15. The operating method of claim 8, wherein the EID-RLOC mapping information includes an EID for identifying an individual terminal, a RLOC for identifying a position of a network to which the corresponding terminal belongs, and an identifier for identifying each tenant in the entire network.
